(19) United States
(12) Patent Application Publication
(10) Pub. No.: US 2006/0080213 A1
(43) Pub. Date: Apr. 13, 2006

(54) Auction methods and system for perishable products

(75) Inventor: Mamoru Inoue, Aichi-ken (JP)

Correspondence Address: MORGAN LEWIS & BOCKIUS LLP, 1111 PENNSYLVANIA AVENUE NW, WASHINGTON, DC, 20004, US

(73) Assignee: Toyoake Flower Co., Ltd.

(21) Appl. No.: 11/069,047

(22) Filed: Mar. 2, 2005

(30) Foreign Application Priority Data
Sep. 2, 2004 (JP) 2004-255754

(51) Int. Cl. G06Q 40/00

(52) U.S. Cl. 705/37

(57) ABSTRACT

An auction system (X) has a marketable auction device 2 to actuate a purchasing scale distinction member (24) provided to distinguish large lot buyers who bid more than 2 unit number from small lot buyers who bid falling short of 2 unit number. A redistribution member (25) works to multiply a factor 1.2 by counterbidding prices that the large lot buyers tender so as to produce estimation prices, while at the same time, producing estimation prices equal to counterbidding prices which the small lot buyers bid without multiplication. Then, the redistribution member (25) determines successful bidders preferentially in order from those who have highest counterbidding prices against the gross unit quantity of the perishable products so that a lowest successful bid price among the successful bidders is determined to be a contract price for all the successful bidders. The auction system (X) enables an auction market to keep higher contract prices through the bidding season so as to enhance the gross net sale without an erratic fluctuation.

### FIELD OF THE INVENTION

The invention relates to an auction system especially used for perishable products which are prone to be consumed for a shorter period of time because they are unstable in fresh supply and not long preservable.

### BACKGROUND OF THE INVENTION

In the auction market open for the perishable products, it is necessary to deal with a larger amount of the perishable products for a shorter period of time. Under these circumstances, a hand sign auction system has been giving a way to a mechanical bidding system as seen in the following documents.

“Welcome to Kinuta floral plant” [online] by Kabushiki Kaisha Tokyo •Kinuta Kaki (searched on Jul. 22, 2004), Internet, <URL:http://www.kinuta-kaki.co.jp/pages/siset.html>

“Meidensha: Information •Communication: Comprehensive Information System For Floral Plant Market”, [online], by Kabushiki Kaisha Meidensha, (searched on Jul. 22, 2004), Internet, <URL:http://www.meidensha.co.jp/prod16/prod16-4d 5.html>

In the mechanical bidding system, only bidding prices are evaluated without taking into consideration the price adjusting mechanism and the continuous purchasing power of large lot buyers (wholesale buyers) in a long term perspective. In some case (e.g., gleaner waiting system, a.k.a. Mari-waiting strategy in Japan) in which a first successful bidder comes, the rest of the commodities can be bought at the successful counterbidding price on a first-come-first-served basis among any counterbidders who desire to join.

In the Mari-waiting system, it ignores the buyers' counterbidding prices so that the rest of the commodities are not delivered in order of the counterbidding prices because the counterbidders are recruited on the first-come-first-served basis once the first successful bidder is selected. This makes only those bidders advantageous who are good at quickly pushing the counterbidders' buttons (quick in knee-jerk response). This type of delivering method renders the bidding system economically inefficient to curtail the consumption surplus so as to shrink the merchandized life without inviting an additional demand for the commodities.

In the so-called stop auction in which the successful bid prices are determined among the counterbidders while watching the price indication board, it is by no means easy to deliver the commodities at an equilibrium price in which demand meets supply regardless of whether it is the Mari-waiting system in Japan or the Dutch clock system in Holland.

The stop auction accompanies with “winner's curse” in which one counterbidder would have his offer accepted at an exceedingly high price compared to other counterbidders' unless the counterbidder has sufficient information about his own asset. In order not to fall into the “winner's curse”, the counterbidders who join the Dutch clock system to take a wait-and-see attitude under certain circumstances. The counterbidders who join the Mari-waiting system have to strategically wait until the scale stops. These situations hinder possible counterbidders to positively join the auction.

In order to solve the “winner's curse”, it is important to adopt the price input system in which the commodities can be delivered at the equilibrium price in which demand meets supply to realize the Paretian optimum, the term of which has been used by economists.

The successful bidder can have his offer accepted under his counterbidding price to provide the consumption surplus without harsh bargaining. This makes it the most profitable strategy to honestly input his own bidding price. This means to completely overcome the “winner's curse”. In this situation, the counterbidders who join the auction can comfortably offer their honest price so as to resultantly stabilize the commodity price.

The mechanical auction system, in contrast, makes the counterbidders sensitive about the tendency of demand to erratically fluctuate price. The strong demand raises the price for initially delivered commodities and popular products firstly introduced in the auction market.

The mechanical auction system has not only no price adjusting function developed in the long term perspective but also is liable to bring commodities left unsold. This is because auction districts that the wholesale market authorizes are specified, and the auction is held between the bid-contracted buyers and the market. It is the case with the auction that the buyers who purchased in the market will not buy the same sorts of commodities until the commodities are completely sold. The demand (transaction prices and transaction lot quantity) successively decreases with the advancement of the auction as shown at a demand curve in FIG. 5.

Since the delivery of the agriproducts continues for a certain period of time, it is necessary to sell them out at stable prices so as to bring the greatest profit to the auction market, while controlling the price hike for the popular and initially introduced commodities.

In the hand sign auction, the auctionee manages the market with the large lot buyers as a main target. This enables the sellers to transact their commodities at a stable price relatively for an extended time period without inviting the price hike for the popular and initially introduced commodities.

In the mechanical auction system, the system reflects the counterbidding price staunchly on the in situ demand to invite the price hike for the popular and initially introduced commodities, while at the same time, the system is likely to increase the number of commodities left unsold near the end of the auction. The mechanical auction system also renders the market price to fall fast so as to prevail the low price commodities, and making the successful bid price fall short of the price asked by the producers.

In this sense, the mechanical auction system adversely affects on the large lot buyers who buy a large lot quantity of the commodities from the reasons below.

Table 1 shows a business category which classifies the buyers registered as of the year 2002 at a major floral auction market of some prefectural quarters in Japan. As apparent from Table 1, the purchasing quantity of the large lot buyers (wholesale buyer, regional market and bulk sales shop) is certainly greater than the purchasing quantity of the small lot buyers. This is because the large lot buyers resale the successfully bidden commodities to retail shops and deliver to branch shops, while the small lot buyers directly sale them to individual consumers.

TABLE 1

| | | purchased | average daily |
|---|---|---|---|
| | | quantity | quantity |
| | | (million yen) | purchased (yen) |
| sorts of buyers | registered number | (%) | per company |
| wholesale buyers | 98 | 9,700 (62.1%) | 1,313,000 |
| regional market | 19 | 757 (4.9%) | 767,000 |
| bulk sales shop | 22 | 1,477 (9.4%) | 1,003,000 |
| retailer's shop | 250 | 3,669 (23.5%) | 220,000 |

TABLE 2

| | | large lot buyers | small lot buyers |
|---|---|---|---|
| 1. | ratio of annual purchased quantity | 76.5% | 23.5% |
| | annual average purchased quantity per company | 4,774 | 1,328 |
| 2. | daily average number of companies joined | 70 | 106 |
| 3. | daily average number of items purchased per company | 106 | 41 |
| 4. | quantity purchased per item | 48 | 32 |
| 5. | attendance rate to auction | 68% | 42% |

Table 2 shows comparison in transaction between the large lot buyers and the small lot buyers in a large scale auction market.

The ratio of annual purchasing amount of money between the large lot buyers and the small lot buyers is approximately represented by 3 to 1 (76.5%:23.5%). The ratio of annual average purchasing amount of money per company between the large lot buyers and the small lot buyers comes to approximately 4 to 1 (4775:1328).

The large lot buyers can find a ready sale through the resale and mass distribution, and afford a relatively short time period until they find another demand for the commodities. The small lot buyers, in contrast, sale the commodities to the individual consumers. They can afford a relatively long time period until they can find another demand for the commodities so that they don't newly buy the commodities by waiting their inventory to be empty.

Although the purchasing power of the large lot buyers is four times the purchasing power of the small lot buyers, the former is 1.5 times the latter in terms of the purchasing lot quantity per item when held under the mechanical auction system.

In the stop auction system in which the buyers push the button to stop the movement of the needle moving through the scale so as to compete the successful bid prices, it is necessary for all the buyers to come together concurrently at the same place. This concurrence works disadvantageous for buyers who join the auction through the communication network. When all the buyers are remote from the auction market, the stop auction system works the buyers disadvantageous more as they are slower and delayed more in terms of communication.

Therefore, in order to overcome the above drawbaks, the invention has for its first object to provide an auction system which is capable of keeping an average contract price high with less fluctuation so as to reap an increased gross net sale.

The invention has for its second object to provide an auction system which is capable of getting remote buyers join the market through a communication network on the same footing without disadvantages.

### SUMMARY OF THE INVENTION

According to the invention, there is provided an auction system including a marketable auction device. In the marketable auction device, a purchasing scale distinction member is provided to totalize counterbidding prices which the buyers input for perishable products under the auction based on counterbidding information which a communication member receives, and distinguish the buyers a large lot group which inputs more than a unit number (r) for the perishable product from a small lot group which inputs falling short of the unit number (r) for the perishable product. A redistribution member is provided to produce estimation prices in which the counterbidding prices are multiplied by a factor (m) for each of the buyers who belong to the large lot group, and producing estimation prices equal to the counterbidding price for each of the buyers who belong to the small lot group so as to determine successful bidders preferentially in order from those who have highest counterbidding prices against the gross unit quantity of the perishable products so that a lowest counterbidding price among the successful bidders is decided to be a contract price for all the successful bidders during the counterbidding process.

This system enables the auction to appreciate the continuous purchasing power for the large lot buyers and the price adjusting function for the perishable products so as to work the large lot buyers advantageous more than the small lot buyers in terms of the bidding transaction.

This system makes the auction market respond less sensitively to the tendency of demand so as to stabilize the price through the the bidding season without the voilent fluctuation.

This system also enables the auction market to implement the price adjustment in the long perspective so as to lessen the perishable products left unsold, and thus further setting an average contract price higher to stably maintain the market price.

This system makes the price unlikely drop even if the producer offers the perishable products with a large lot delivery, and thus enabling the auction market to reap an increased gross net sale through the bidding season. This also eliminates the strategy in which the buyers wait until the first successful bidder comes upon so as to join the Mari-waiting session (gleaner waiting system) by quickly pushing the button as soon as the first successful bidder is selected.

This system eliminates the necessity for all the counterbidders to come together concurrently at the same place to compete the auction prices, and thus making it the most profitable strategy to honestly input his own counterbidding price.

This system makes the auction less disadvantageous for the buyers joining remote from the auction market through the communication network. This renders the auction convenient for the counterbidders dwelling remote from the auction market. In this instance, the auction system enables the counterbidders to join on the same footing regardless of whether they are slower and delayed more in terms of communication.

According to other aspect of the invention, the perishable products are items to be consumed for a shorter period of time because they are unstable in fresh supply and not long preservable. By way of illustration, these are floral plants, agriproducts, cattle products and marine products.

According to other aspect of the invention, the relationship between the predetermined unit number (r) and the factor (m) is defined as 2≦r≦3³ and 1<m<1.5.

The predetermined unit number means the number (1, 2, 3, . . . n) of the perishable products which the counterbidders can buy in the auction. When the unit number (r) is 1, it becomes difficult to distinguish the large lot buyers from the small lot buyers. This is because it is very seldom from the experience that the auction has ever held with the unit number (r) exceeding the numerical value 3³.

As regard the factor (m) which derives the estimation prices when the large lot buyers respectively input the counterbidding prices, it is preferable that the factor (m) exceeds 1 but falling short of 1.5. When the factor (m) exceeds 1.5, the factor makes the purchasing motivation recede for the small lot buyers so as to decrease the gross net sale more than the case in which the usual distribution is applied (m=1). This numerical arrangement of the factor (m) makes it possible to appropriately distinguish the large lot buyers from the small lot buyers without declining the purchasing motivation of the small lot buyers, thus making the large lot buyers advantageous more properly than the small lot buyers so as to reap the increased gross net sale during the bidding season.

According to other aspect of the invention, when the buyers input the counterbiding unit number for the perishable products together with the counterbidding prices through the counterbidding information input member of the joint transaction terminals. When the buyers set the counterbidding unit number more than the predetermined unit number (r), the buyers are regarded to belong in the large lot group. When the buyers set the counterbidding unit number falling short of the predetermined unit number (r), the buyers are regarded to belong in the small lot group. The unit number (r) used to distinguish the large lot group from the small lot group is to be determined depending on the gross unit quantity and a marketable scale of the perishable products. When the gross unit quantity of the perishable products and the marketable scale are large, the unit number (r) is set higher (r=3, 4, 5, 6, . . . , n) so as to highten the counterbidding threshold for the large lot buyers, thus making it possible to appropriately distinguish the large lot buyers from the small lot buyers.

According to other aspect of the invention, the factor (m) which derives the estimation price is set greater as the purchasing power of the large lot buyers becomes bigger than the purchasing power of the small lot buyers. This is because it is necessary to make the large lot buyers more advantageous than the small lot buyers as the former's purchasing power becomes greater than the latter's purchasing power.

Considering that the more the gross net quantity of the perishable products increase, the longer the time period becomes during which the auction is held, the factor (m) is set to be greater with the increase of its gross net quantity so as to make the large lot buyers advantageous. From the necessity for the counterbidding prices to be properly supported by the large lot buyers at the start of the auction, the factor (m) is set to be greater as the time elapsed is sooner after the auction starts. This arrangement makes it possible to render the large lot buyers advantageous more appropriately than the small lot buyers irrespective of the purchasing power of the large lot buyers, the ratio of the small lot buyers to the large lot buyers, the bidding duration for the perishable products and the time period elapsed after the auction starts.

### BRIEF DESCRIPTION OF THE DRAWINGS

Preferred forms of the present invention are illustrated in the accompanying drawings in which:

FIG. 1 is a block diagram of an auction system according to first and second embodiments of the invention;

FIG. 2 is a graphical representation involving how contract prices change during a bidding season in the conventional auction system and the subject auction system;

FIG. 3 is an algorithm showing how the auction system is caried out;

FIG. 4 is a graphical representation involving how gross net sale changes when simulations 3 and 4 are applied in the second embodiment of the invention;

FIG. 5 is a graphical representation involving how gross net sale changes when simulation 5 is applied in the second embodiment of the invention; and

FIG. 6 is a three-dimensional image showing a demand curve in a usual fashion.

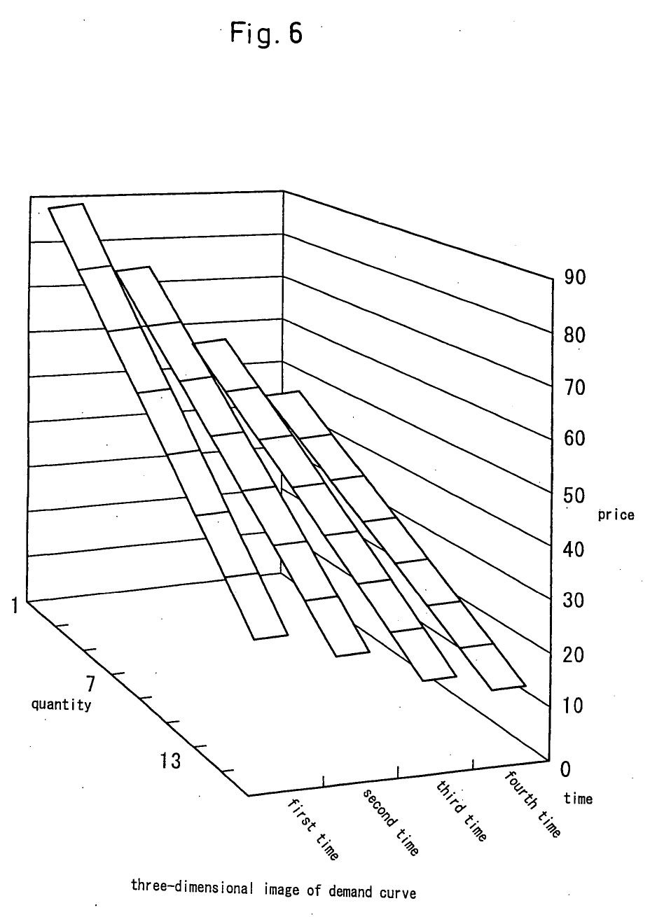

### BEST MODES FOR CARRYING OUT THE PRESENT INVENTION

The auction system for perishable products has a marketable auction device equipped with a monitor indicating the bidding information about commodities, bidding process, and results earned after offering counterbidding prices. Input keys are provided to input counterbidding information (counterbidding price and counterbidding unit number). A terminal communication network is provided to transmit and receive the counterbidding information and the bidding information. A communication network is provided to transmit and receive the counterbidding information and the bidding information between joint transaction terminals which the buyers operate, and the terminal communication network of the joint transaction terminals. A purchasing scale distinction member is provided to totalize counterbidding prices which the buyers input for perishable products based on the counterbidding information so as to distinguish the large lot buyers (bidden more than 2 unit number) from the small lot buyers (bidden short of 2 unit number) among the buyers. A redistribution member is provided to produce estimation prices in which the counterbidding prices are multiplied by a factor (m) for each of the buyers who belong to the large lot group, and producing estimation prices equal to the counterbidding price for each of the buyers who belong to the small lot group so as to determine successful bidders preferentially in order from those who have highest counterbidding prices against the gross unit quantity of the commodities so that a lowest counterbidding price among the successful bidders is decided to be a contract price for all the successful bidders during the counterbidding process. The structure is such that it is possible for the auction to evaluate the continuous purchasing power for the large lot buyers and the price adjusting function for the perishable products so as to render the large lot buyers advantageous more than the small lot buyers in terms of the bidding transaction, and thus stabilizing the auction price to increase the gross net sale during the bidding season without the voilent fluctuation. This also eliminates the Mari-waiting strategy in which the buyers wait until the first successful bidder comes upon so as to join the Mari-waiting session by quickly pushing the button as soon as the first successful bidder is selected, and thus removing the necessity for all the counterbidders to come together concurrently at the same place to compete the auction so as make it the most profitable strategy to honestly input his own bidding price. This renders the auction convenient for the counterbidders dwelling remote from the auction market to enable the counterbidders to join on the same footing through the communication network.

### DETAILED DESCRIPTION OF THE PREFERRED EMBODIMENTS OF THE INVENTION

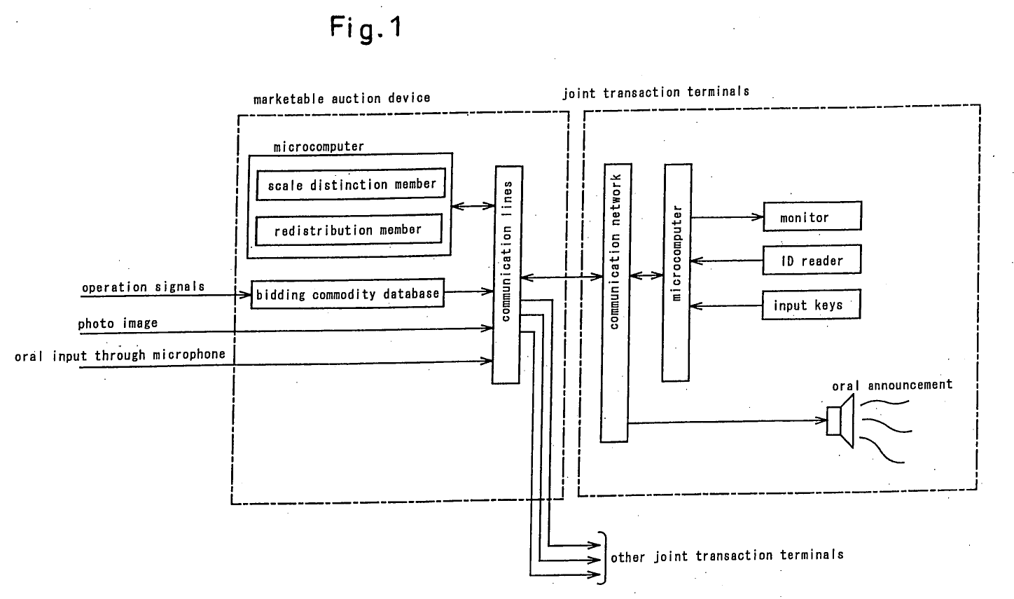

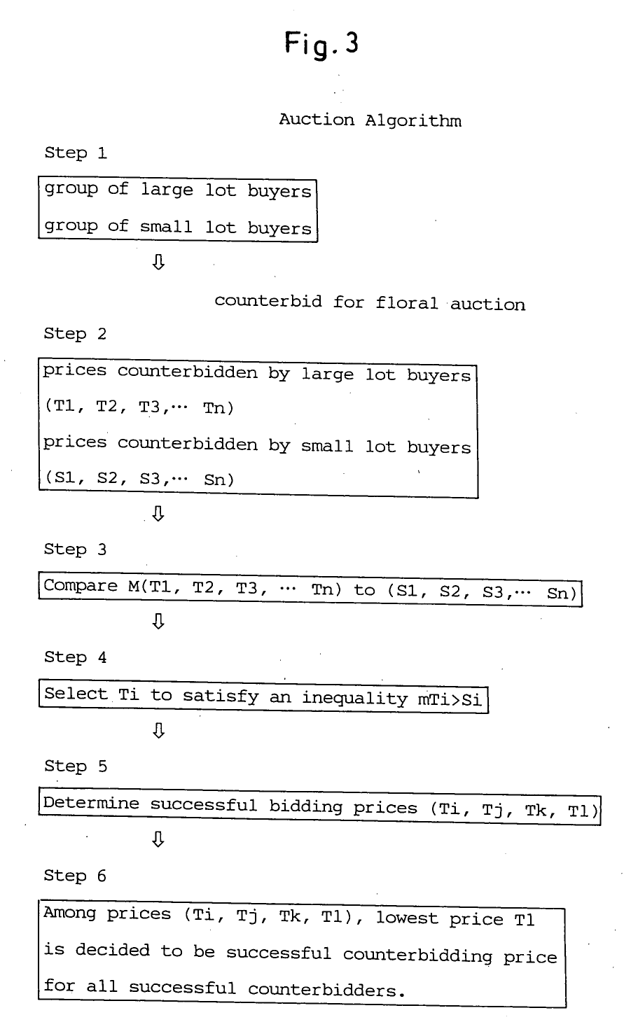

Referring to FIGS. 1 and 3, an auction system X according to a first embodiment of the invention has a plurality of joint transaction terminals 1 which are to be operated by buyers each collated by their own identification card. The auction system X further has a marketable auction device 2 provided to implement the auction so as to decide successful bidders and contract prices.

The joint transaction terminals 1 are respectively placed at the buyers' respective seats in an auction market (not shown). The joint transaction terminals 1 have a monitor 11 as an indicator member, an ID reader 12 and input keys 13 as counterbidding information input member. By way of a microcomputer 14 and a communication network 15 provided to act as a terminal communication member, a speaker 16 is connected to do oral announcement. The monitor 11 displays commodity information such as name, size number, gross net quantity and origin together with auction information such as bidding process, counterbidding results regarding perishable products (floral plants) for the sake of the buyers in the auction market.

The commodity information, the bidding process and the auction information displayed through the monior 11 are converted into digital data (image and audio) stored in a bidding commodity database 23, or changed into a live image (movie or still image) through a camera provided to take a picture of an auction cell (not shown) in which the floral plants are carried to pass. Also used to the display are figures and characters prepared by the microcomputer 22 based on successful bidding results.

The ID reader 12 reads out ID cards provided to magnetically memorize the individual buyers' verification items so that the buyers have themselves indentified in the auction market. The input keys 13 work as a plurality of buttons provided to input counterbidding prices and counterbidding unit number for the floral plants to be auctioned. The respective buttons have different numbers printed on the upper end surface.

The communication network 15 is wire communicable with communication lines 21 of the marketable auction device 2 in dual directions to receive the bidding information from the auction marketable device 2 and transmit the counterbidding information to the marketable auction device 2. The counterbidding information signifies the counterbidding prices and the counterbidding unit number (prices and amounts in which the individual bidders wish to buy in the auction market) which are inputted by the individual buyers through the input keys 13.

The speaker 16 sounds voices recorded in the auction market, and vocally explains the commodities regarding the floral plants stored in the bidding commodity database 23 while orally noticing the bidding process together with the counterbidding results.

The marketable auction device 2 is secured at an appropriate place within the premise of the auction market, and having the communication lines 21, the microcomputer 22 and the bidding commodity database 23. The communication lines 21 are wire communicable with the communication network 15 of the joint transaction terminals 1 in dual directions. The communication lines 21 receive the counterbidding information from the individual joint transaction terminals 1 and transmit the bidding information to the individual joint transaction terminals 1.

The bidding information which the marketable auction device 2 transmits to the individual joint transaction terminals 1 includes the floral information (name, size number, gross net quantity and origin), the bidding process (bidding preparation, in progress and end of the bidding) and counterbidding results (successfully bidden, yet to be successfully bidden and contract prices).

The bidding commodity database 23 stores all the floral commodity information presently transacted in the auction market. When an auctionee operates a switch (not shown) to input electronic signals to the marketable auction device 2, the corresponding floral data are transmitted from the marketable auction device 2 to the individual joint transaction terminals 1 through the communication lines 21 and the communication network 15.

The microcomputer 22 has a purchasing scale distinction member 24 which distinguishes large lot buyers from small lot buyers among the bidders joined to the auction market. A redistribution member 25 is programmably provided to implement the counterbidding operation in the auction market.

Based on the counterbidding information which the communication lines 21 receive, the purchasing scale distinction member 24 collects counterbidding prices which all the buyers input via the keys 1 against the floral products quoted in the auction market. The purchasing scale distinction member 24 divides the bidding buyers into two groups. One is the large lot buyers who input more than 2 unit number (more than the predetermined unit number (r)) as the counterbidding unit number. Another is the small lot buyers who input short of 2 unit number (short of the predetermined unit number (r)) as the counterbidding unit number.

The redistribution member 25 multiplies the counterbidding prices by 1.2 as a multiplication factor (m) to produce estimation prices when the counterbidding prices are resulted from the large lot buyers whom the purchasing scale distinction member 24 recognizes as such. The redistribution member 25 regards the counterbidding prices as estimation prices when the counterbidding prices are resulted from the small lot buyers whom the purchasing scale distinction member 24 recognizes as such. Then, the redistribution member 25 decides successful bidders preferentially in order from those who have the highest counterbidding prices against the gross net quantity of the floral products quoted in the auction market, so that a lowest counterbidding price among the successful bidders is determined as a contract price for all the successful bidders so as to constitute a large transaction system (abbreviated as “LTS” hereinafter) during the counterbidding process. These procedures are epitomized in FIG. 3.

In this instance, the multiplication factor (m) is also defined as an advantage multiplication hereinafter.

The following are tangible examples how the quoted floral products are distributed due to the purchasing scale distinction member 24 and the redistribution member 25.

Table 3 shows an example in which the buyers A-J offer their counterbidding prices and counterbidding unit number (r) through the keys 13 of the joint transaction terminals 1 with the gross net unit as 3 against the quoted floral products. As a result, a relationship is gained between a bidding estimation and successful bid distribution.

TABLE 3

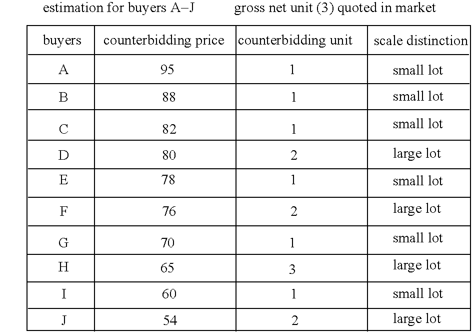

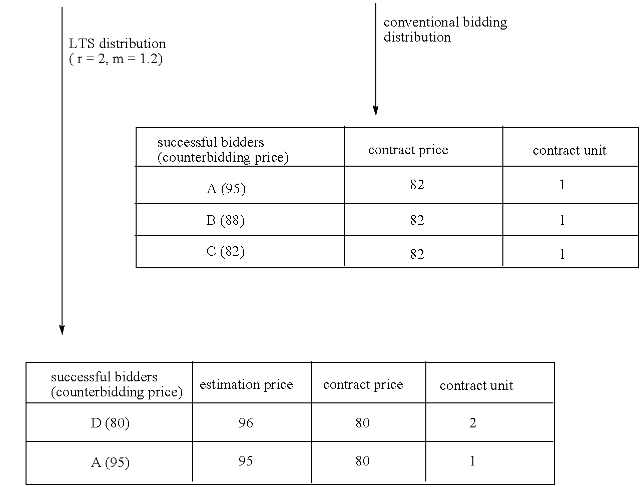

The purchasing scale distinction member 24 collects the counterbidding prices and the counterbidding unit number (r), and recongnizes the buyers A, B, C, E, G and I to be the small lot buyers whose counterbidding unit number (r) comes to 1, while recognizing the buyers D, F, H and J to be the large lot buyers whose counterbidding unit number (r) is more than 2. The redistribution member 25 multiplies the counterbidding prices 80, 76, 65, 54 by 1.2 to produce the estimation prices 96, 91.2, 78 and 64.8 for the large lot buyers D, F, H and J. The redistribution member 25 regards the counterbidding prices 95, 88, 82, 78, 70 and 60 as their estimation prices for the small lot buyers A, B, C, E, G and I.

Then, the redistribution member 25 decides the successful bidders in order from those who have the highest counterbidding prices until the gross unit quantity is bidden so that a lowest counterbidding price (80) is determined through LTS to be a contract price for all the successful bidders (A, D).

First successful bidder: buyer D: L=80, M=96, N=80, Q=2

Second successful bidder: buyer A: L=95, M=95, N=80, Q=1
buyer F: L=91.2
buyer B: L=88
buyer C: L=82
buyer E: L=78
buyer H: L=78
buyer G: L=70
buyer J: L=64.8
buyer I: L=60

The conventional bidding system distributes the floral products to the successful bidders preferentially in order from those who have highest counterbidding prices until the gross unit quantity is bidden so that a lowest counterbidding price (82) is determined to be a contract price for all the successful bidders (A, B, C).

First successful bidder: buyer A: L=95, N=82, Q=1

Second successful bidder: buyer B: L=88, N=82, Q=1

Third successful bidder: buyer C: L=82, N=82, Q=1
buyer D: L=80
buyer E: L=78
buyer F: L=76
buyer G: L=70
buyer H: L=65
buyer I: L=60
buyer J: L=54

L: counterbidding price

M: estimation price

N: contract price

Q: contract unit

At the next stage, an estimation model is set to more precisely comprehend behaviors of the large lot buyers in a long perspective. Suppose that the large lot buyers have an ability to sell the successfully bidden commodities by four units for four days, while the small lot buyers have an ability to sell the successfully bidden commodities by one unit for four days. The large lot buyers buy the commodities by two or three units, while the small lot buyers buy the commodities by one unit.

The large lot buyers stay away the auction on the following day after they bought the commodities so as to buy new commodities two days after joining the auction. Once the small lot buyers bought the commodities, they stay away the auction until four days pass after they first joined the auction.

In the premise that the buyers A-J offer their counterbidding prices and counterbidding unit as shown at Table 3, Table 4 shows results after implementing the conventional bidding system for four consecutive days. Table 5 shows results earned after implementing LTS for four consecutive days.

TABLE 4
conventional auction system results after four-time bidding

| | counterbidding | counterbidding | | first | second | third | fourth | |
|---|---|---|---|---|---|---|---|---|
| buyers | price | unit | scale distinction | time | time | time | time | |
| A | 95 | 1 | small lot | (1) | recess | recess | recess | |
| B | 88 | 1 | small lot | (1) | recess | recess | recess | |
| C | 82 | 1 | small lot | (1) | recess | recess | recess | |
| D | 80 | 2 | large lot | | (2) | recess | (2) | |
| E | 78 | 1 | small lot | | (1) | recess | recess | |
| F | 76 | 2 | large lot | | | (2) | recess | |
| G | 70 | 1 | small lot | | | (1) | recess | |
| H | 60 | 1 | small lot | | | | (1) | |
| I | 59 | 3 | large lot | | | | | |
| J | 54 | 2 | large lot | | | | | seasonal gross net sale |

| | | | | | |
|---|---|---|---|---|---|
| contract price | 82 | 78 | 70 | 60 | 870 |

( ): successful bid
recess: demand extinct due to successful bid

TABLE 5
LTS auction (first embodiment) results after four-time bidding (m = 1.2)

| | counterbidding | counterbidding | | LTS | first | second | third | fourth | |
|---|---|---|---|---|---|---|---|---|---|
| buyers | price | unit | scale distinction | estimation | time | time | time | time | |
| A | 95 | 1 | small lot | | (1) | recess | recess | recess | |
| B | 88 | 1 | small lot | | | (1) | recess | recess | |
| C | 82 | 1 | small lot | | | | (1) | recess | |
| D | 80 | 2 | large lot | 96 | (2) | recess | (2) | recess | |
| E | 78 | 1 | small lot | | | | | (1) | |
| F | 76 | 2 | large lot | 91.2 | | (2) | recess | (2) | |
| G | 70 | 1 | small lot | | | | | | |
| H | 60 | 1 | small lot | | | | | | |
| I | 59 | 3 | large lot | 70.8 | | | | | |
| J | 54 | 2 | large lot | 64.8 | | | | | seasonal gross net sale |

| | | | | | |
|---|---|---|---|---|---|
| contract price | 80 | 76 | 80 | 76 | 906 |

( ): successful bid
recess: demand extinct due to successful bid

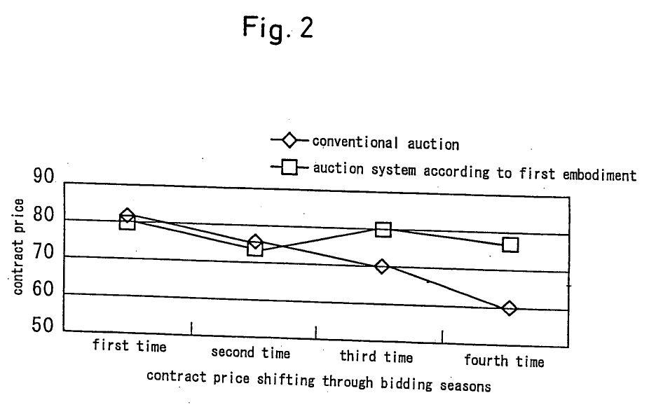

In connection with Tables 4 and 5, a graphical representation shows in FIG. 2 how the contract prices shift from the first day to fourth day through the bidding season. The conventional auction system has a tendency to let the contract price rapidly fall with the progress of the auction. The LTS auction, in contrast, has a trend to make the contract prices stably move while keeping them high. In the LTS auction, the large lot buyers who have a short buying time period duration are placed advantageous under the auction market with the commodities preferentially distributed for the large lot buyers. Compared to the conventional auction system, it was found that the LTS auction increases the seasonal gross net sale with the price fluctuation effectively controlled.

With the structure thus far described about the marketable auction device 2 of the auction system X, the purchasing scale distinction member 24 collects the counterbidding prices and the counterbidding unit against the floral commodities which all the buyers tender through the input keys 13. The purchasing scale distinction member 24 further distinguishes the large lot buyers who bid more than 2 unit number from the small lot buyers who bid falling short of 2 unit number based on the counterbidding information. Then, the redistribution member 25 multiplies the factor 1.2 (m) by the counterbidding prices which the large lot buyers bid to produce their estimation prices, while regarding the counterbidding prices which the small lot buyers bid as their estimation prices. The redistribution member 25 further decides the successful bidders preferentially in order from those who have highest counterbidding prices against the three gross net units of the floral products quoted in the auction market, so that the lowest counterbidding price among the successful bidders is determined as the contract price for all the successful bidders (LTS distribution).

By multiplying the factor 1.2 (m) by the counterbidding prices so as to produce the estimation prices, these procedures evaluate the consecutive purchasing power and the price adjusting function which the large lot buyers rules, thus making the large lot buyers more advantageous than the small lot buyers upon bidding the floral commodities.

Considering that the delivery of the floral commodities continues for a certain period of time, it is necessary to control the price hike for popular and initially introduced floral commodities, and sell them out with the stable price through the seasonal period in order for the auction market to reap an increased gross net sale.

With the use of the auction system X, it is possible to preferentially treat the large lot buyers so as to control the initial hike of the counterbidding prices, thus enabling the auction market to sell the floral commodities with the stable prices for a certain period of time.

The auction system X makes it possible for the auction market to respond less sensitively to the demand so as to stabilize the marketable price with less fluctuation through the bidding season. For this reason, the demand for the popular and initially introduced floral commodities is properly controlled so as to suppress the hike of the counterbidding prices. This makes it possible to implement the price adjusting function in the long perspective, thus enabling the auction market unlikely to have the floral commodities left unsold at the final stage of the auction, while preventing the counterbidding price from falling under the asking prices from the floral producers. This is because it is important for the auction market to faithfull keep selling the floral commodities in which the asking prices are tagged by the commodity producers to have the floral commodities consecutively delivered from the commodity producers.

In the auction market in which the LTS distribution is adopted, the large lot buyers tend to positively buy since they can buy the floral commodities approximately at 83% of the counterbidding prices which the small lot buyers bid. For this reason, the LTS distribution enables the auction market to seek the potential purchasing power of the large lot buyers to build up the gross net sale during the bidding season so as to reap an increased profit for the auction market.

In the auction system X which eliminates the gleaner-waiting strategy (Mari-waiting strategy) in which new bidders are recruited on the first-come-first-served basis when the floral commodities are knocked down to the first successful bidders, the counterbidding prices are justly evaluated to make the auction system X economically efficient, thus calling the consumption surplus to swell the additional demand so as to extend a bidding life span for the floral commodities.

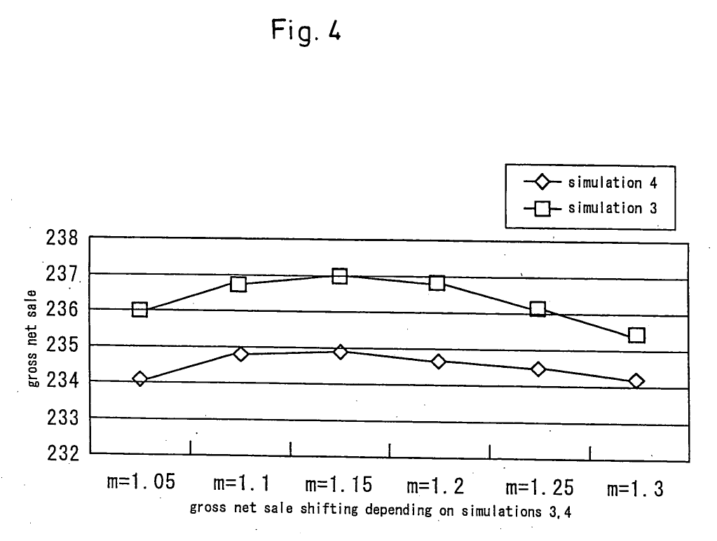

Referring to FIGS. 3 and 4, a second embodiment of the invention is described below. An auction system Y is different from the auction system X in that the microcomputer 22 has the purchasing scale distinction member 24 and the redistribution member 25 which are programmably assembled to work in the following manner. The purchasing scale distinction member 24 collects the counterbidding prices and the counterbidding unit against the floral commodities which all the buyers bid through the input keys 13, and distinguishes the large lot buyers who bid more than the predetermined unit number (r) from the small lot buyers who bid falling short of the unit number (r) based on the counterbidding information which the communication lines 21 receives. The counterbidding unit number (r) ranges from 2 to 3³ determined by the administrative auctionee depending on the scale of the auction market and the gross net unit for the floral commodities quoted in the auction market.

The redistribution member 25 multiplies the factor (m) by the counterbidding prices which the large lot buyers bid to produce their estimation prices, while regarding the counterbidding prices which the small lot buyers bid as their estimation prices. The redistribution member 25 further decides the successful bidders preferentially in order from those who have highest counterbidding prices against the three gross net units of the floral products quoted in the auction market, so that the lowest counterbidding price among the successful bidders is determined as the contract price for all the successful bidders (LTS distribution).

The auction system Y uses the advantage multiplication (m) which the administrative auctioneer determines in accordance with the following conditions within the predetermined range (1<m<1.5).
(a) The advantage multiplication (m) gets larger as the purchasing power of the large lot buyers grow greater.
(b) The advantage multiplication (m) becomes larger as the ratio gets greater which the large lot buyers occupy.
(c) The advantage multiplication (m) gets larger for the floral commodities as the time period gets longer in which the floral commodities are transacted in the auction market.
(d) The advantage multiplication (m) is determined to be greater at the first day of the auction, and successively decreasing as the auction advances. Based on the data derived from Tables 1 and 2, an estimation model I is provided to implement a simulation 1.
   [Simulation 1]
   (Estimation Model I)
(a) The counterbidding prices which the buyers bid against the floral commodities are uniformly distributed within the range of 0-100.
(b) The number of buyers who join the auction is 10 including five large lot buyers and 5 small lot buyers.
(c) The ratio of the purchasing power of the large lot buyers to that of the small lot buyers is 1:4.

Suppose that once the small lot buyers buy the floral commodities, they will not buy ones until four days elapse after the following day they bought them. In this instance, the small lot buyers buy the floral commodities at most by one unit per auction since the floral commodities are perishable products not preservable for an extended time period.

The large lot buyers can sell one unit a day. Once they bought the floral commodites by two units, they will stay away from the auction on the following day until two days pass after they bought the floral commodities in the auction. The large lot buyers usually buy the floral commodities by two units, but they would have to buy only one unit in view of the commodities left unsold. They will buy the floral commodities by one unit on the following day so that they are regarded as the small lot buyers. Namely, the quantity which the large lot buyers consecutively buy the floral commodities amounts to two unit at most. The auction continues for four days with three units of the floral commodities quoted each day. The predetermined unit number (r=2) serves as a standard number to distinguish the large lot buyers from the small lot buyers with the advantage multiplication (m) adopted as 1.2.

Based on the estimation model (I) structured by the personal computer, one thousand times of simulations have been repeated in accordance with the uniform distribution by altering the distribution conditions. As a result, an average gross net sale for four days, an average contract price and an average standard deviation of the contract prices for four days are obtained as shown at Table 6 for the conventional auction system and the auction system Y (LTS distribution).

TABLE 6
result of simulations repeated one thousand times (m = 1.2)

| | | conventional |
|---|---|---|
| | LTS distribution | auction |
| gross net sale averaged for four days | 256.44 | 254.86 |
| contract price on average | 64.11 | 63.72 |
| average standard deviation of | 10.88 | 11.46 |
| the contract prices for four days | | |

TABLE 7
result of simulations repeated one thousand times (m = 1.2)

| | | |
|---|---|---|
| same distribution result gained | times of incidences | 411 times |
| LTS distribution result is superior | times of incidences | 250 times |
| | average difference | 14.55 |
| | amounted per auction | |
| conventional bidding distribution | times of incidences | 399 times |
| result is superior | average difference | 6.08 |
| | amounted per auction | |

It is found that the auction system Y is greater than the conventional auction system in terms of the average gross net sale for four days and the average contract price. It is also found that the auction system Y is less varied than the conventional auction system in terms of the average standard deviation of the contract prices for four days.

Depending on the sorts of the distribution, the auction system Y would be almost the same as the conventional auction system in terms of the distribution result. The conventional auction system would be greater than the auction system Y in terms of the average gross net sales (see Table 7). As shown in Table 7, the conventional auction system is greater than the auction system Y by 339 times in terms of the average gross net sale among one thousand repeated times. The number of 339 times exceeds the number of 250 times in which the auction system Y becomes greater than the conventional auction system in terms of the average gross net sale.

The auction system Y, however, brings a bigger difference between the two systems each time when the auction system Y is greater than the conventional auction system in terms of the average gross net sale so as to result in an increased average gross net sale for four days as a whole. In other words, the conventional auction system exceedingly decreases the contract prices at the latter half of the auction, while the auction system Y is capable to hold the contract prices from falling down so as to keep the bidding prices higher (see FIG. 2).

[Simulation 2]

(Estimation Model II)

An estimation model II is structured in the same manner as the estimation model I except for the advantage multiplication (m) arranged to range from 1.05 to 1.35. The conventional auction system and the auction system Y are simulated one thousand times on the personal computer against the varied distribution conditions in accordance with the uniform distribution. The results are raised as the number of incidences and a gross net sale averaged for four days in Tables 8 and 9. In this instance, the auction system Y adopts the advantage multiplication (m) as 1.05, 1.1, 1.15, 1.2, 1.25, 1.3, 1.35.

TABLE 8

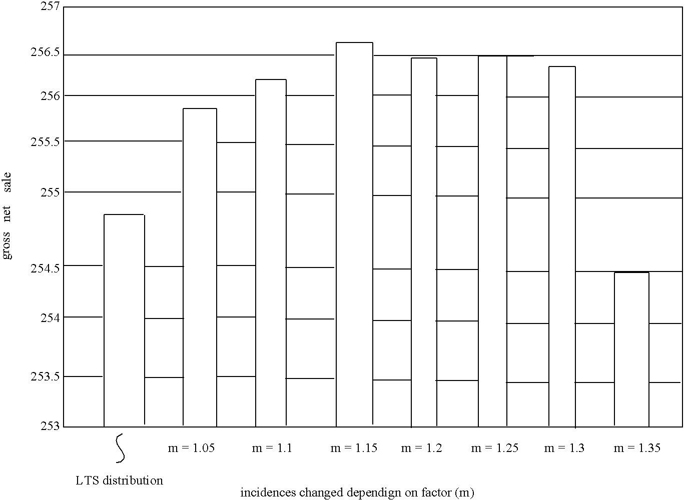

TABLE 9

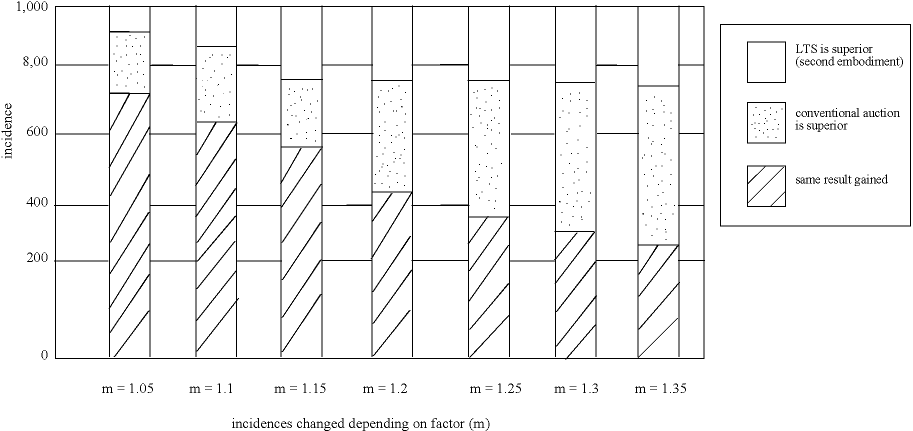

As for the gross net sale averaged for four days, it is found from Table 8 that the auction system Y can yield greater than the conventional auction system when the advantage multiplication (m) ranges from 1.05 to 1.3. The greatest gross net sale averaged for four days is yielded when the advantage multiplication (m) falls on 1.15.

With the increase of the advantage multiplication (m), the purchasing power of the large lot buyers swell to build up the transaction quantity in the auction market. The large lot buyers, however, pay not in terms of the estimation prices, but in terms of contract prices (counterbidding prices). For this reason, a greater advantage multiplication (m) invites a loss in the gross net sale.

It is found from Table 9 that with the increase of the advantage multiplication (m), the distribution due to the conventional auction system tends to be greater than the distribution due to the auction system Y (LTS) in terms of the gross net sales averaged for four days.

[Simulation 3]

(Estimation Model III)

In an estimation model III used to a simulation 3, the distribution conditions of the counterbidding prices are altered as below.

Considering that the large lot buyers are very sensitive to the price because they purchase the floral products in bulk, the distribution of the counterbidding prices which the large lot buyers bid against the floral products is uniform in the range of 0-90. The distribution of the counterbidding prices which the small lot buyers bid against the floral products is uniform in the range of 0-100. With the advantage multiplication (m) set at 1.05, 1.1, 1.15, 1.2, 1.25 and 1.3, the auction system Y are simulated one thousand times on the personal computer against the varied distribution conditions in accordance with the uniform distribution. The results are raised as a gross net sale averaged for four days as shown at square sign □ in FIG. 4. The simulation 3 can yield good results (m=1.1-1.2), and earn the greatest gross net sale when the advantage multiplication (m) falls on 1.15.

[Simulation 4]

(Estimation Model IV)

In an estimation model IV used to a simulation 4, the constituent ratio of the large lot buyers to the small lot buyers is determined as below.

In the auction market placed in the proximity of the floral producers to represent the origin, the constituent ratio is determined to be 1:1 in the simulations 1-3. In the urban auction market in which the number of the small lot buyers surpasses the number of the large lot buyers, the constituent ratio is determined to be 4:6 so that the buyers who join the auction market is 10 in total (four for the large lot buyers and six for the small lot buyers).

With the advantage multiplication (m) set at 1.05, 1.1, 1.15, 1.2, 1.25 and 1.3, the auction system Y is simulated one thousand times on the personal computer against the varied distribution conditions in accordance with the uniform distribution. The results are raised as a gross net sales averaged for four days as shown at rhombic sign 0 in FIG. 3. The simulation 4 can yield good results (m=1.1-1.15), and earn the greatest gross net sale when the advantage multiplication (m) falls on 1.15.

[Simulation 5]

(Estimation Model V)

In an estimation model V used to a simulation 5, the ratio of the large lot buyers to the small lot buyers in terms of purchasing power is determined as below.

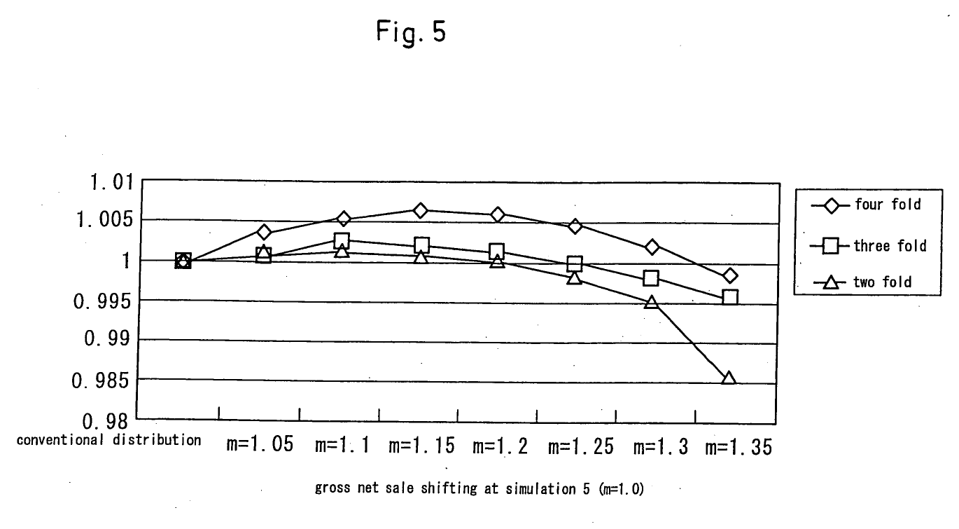

The ratio in terms of purchasing power is determined to be 1:4 (four-fold) in the simulations 1-4. The estimation model V adopts 1:3 (three-fold) and 1:2 (two-fold) with the advantage multiplication (m) set at 1.05, 1.1, 1.15, 1.2, 1.25, 1.3 and 1.35. The auction system Y is simulated one thousand times on the personal computer against the varied distribution conditions in accordance with the uniform distribution. The results are raised as a gross net sale averaged for four days as shown in FIG. 5. The simulation 5 can yield a local maximum gross net sale when the advantage multiplication (m) falls on 1.15, 1.10 and 1.05 each corresponding to the four-fold, three-fold and two-fold in terms of the purchasing power ratio.

As understood from the above description, the purchasing scale distinction member 24 in the auction system Y uses the predetermined unit number (r) within the range of 2-3³ to distinguish the large lot buyers from the small lot buyers. The predetermined unit number (r) is set by the administrative auctioneer depending on the auction market scale and the gross net quantity of the floral products quoted in the auction market. This makes it possible to appropriately distinguish the large lot buyers from the small lot buyers regardless of where the auction market is situated.

The auction system Y has the advantage multiplication (m) provided to multiply (m) by the counterbidding prices which the large lot buyers bid. The advantage multiplication (m) is set within the certain range (1<m<1.5) by the administrative auctioneer. The advantage multiplication (m) is set to be greater as the large lot buyers get the purchasing power more, the large lot buyers occupy the constituent ratio more, the perishable products increase more which are to be put on the auction longer and the time period elasped is sooner after the auction starts.

This enables the auctioneer to place the large lot buyers advantageous more appropriately than the small lot buyers irrespective of the purchasing power, the constituent ratio, the effective period of the perishable products or the time elasped after the auction starts. This cultivate the potential purchasing power of the large lot buyers to maximize the gross net sale of the floral products so as to render the auction market the most profitable.

It is to be noted that the joint transaction terminals 1 may be placed outside the auction market so as to connect the marketable auction device 2 to the joint transaction terminals 1 through an authorized network or an internet lines.

The auction system Y renders the auction convenient for the bidders dwelling remote from the auction market to enable the bidders to join on the same footing through the communication network. In this instance, the auction system Y enables the bidders to join on the same footing regardless of whether they are slower and delayed more in terms of communication (temporal difference at inputting the counterbidding information).

It is also to be noted that the perishable products are items to be consumed for a shorter period of time because they are unstable in fresh supply and not preservable for a long period of time. These may be agriproducts, cattle products or marine products instead of the floral products.

What is claimed is:

1. An auction system including a marketable auction device comprising:
an indicator member provided to indicate a commodity information about a gross unit quantity of perishable products transacted in an auction market, while at the same time, indicating auction information involving a process how the auction advances, and counterbidding results gained upon bidding the perishable products in said auction market;
a counterbidding information input member provided for a plurality of buyers who join the auction market to input counterbidding prices and counterbidding quantity of the perishable products which the buyers wish to purchase;
a terminal communication member provided to transmit and receive counterbidding information and said auction information;
a plurality of joint transaction terminals provided to be operated by said buyers who join the auction market;
a communication member provided to transmit and receive said counterbidding information and said auction information between said joint transaction terminals and said terminal communication member;
a purchasing scale distinction member provided to totalize said counterbidding prices which the buyers input for the perishable products under the auction market based on said counterbidding information which said the communication member receives, and distinguishing a large lot group which inputs more than a predetermined counterbidding unit number (r) for the perishable products from a small lot group which inputs short of said predetermined counterbidding unit number (r) for the perishable products;
a redistribution member provided to produce estimation prices in which said counterbidding prices are multiplied by a factor (m) for each of the buyers who belong to said large lot group, and producing estimation prices equal to said counterbidding prices for each of the buyers who belong to said small lot group so as to determine successful bidders preferentially in order from those who have highest counterbidding prices against said gross unit quantity of said perishable products so that a lowest counterbidding price among said successful bidders is decided to be a contract price for all the successful bidders during the counterbidding process.

2. An auction system according to claim 1, wherein said perishable products include floral products, agriproducts, cattle products and marine products which are to be consumed for a shorter period of time because they are unstable in fresh supply and not long preservable.

3. An auction system according to claim 1, wherein the following relationship is defined between said predetermined unit number (r) and said factor (m).
2≦r≦3³ and 1<m<1.5

4. An auction system according to claim 3, wherein said unit number (r) is determined depending on the gross unit quantity and a marketable scale of said perishable products.

5. An auction system according to claim 1, wherein said factor (m) is determined to be higher as a purchasing power of the buyers belonging to said large lot group become stronger, as a ratio of the buyers occupying said large lot group becomes greater, as said perishable products are placed longer under said auction market and as the time elapsed is sooner after the auction starts.
